(19) United States
(12) Patent Application Publication
(10) Pub. No.: US 2026/0264474 A1
(43) Pub. Date: Sep. 10, 2026

(54) AIR CONDITIONER FOR VEHICLE

(71) Applicant: SANDEN CORPORATION, Isesaki-shi, Gunma (JP)

(72) Inventors: Yasunori TAKAYAMA, Isesaki-shi, Gunma (JP); Hongming ZHANG, Isesaki-shi, Gunma (JP); Yunsheng HUANG, Isesaki-shi, Gunma (JP); Takahiro TOMARU, Isesaki-shi, Gunma (JP); Xingwen FENG, Isesaki-shi, Gunma (JP); Takefumi TOMIYA, Isesaki-shi, Gunma (JP); Hiroto MAJIMA, Isesaki-shi, Gunma (JP)

(73) Assignee: SANDEN CORPORATION, Isesaki-shi, Gunma (JP)

(21) Appl. No.: 19/164,493

(22) PCT Filed: Jun. 7, 2024
(86) PCT No.: PCT/JP2024/020830

§ 371 Date: Sep. 11, 2025

(30) Foreign Application Priority Data
Jun. 20, 2023 (JP) 2023-101046
May 14, 2024 (JP) 2024-078976

(51) Int. Cl. B60H 1/00; B60H 1/32; F25B 49/02

(52) U.S. Cl. CPC B60H 1/00899; B60H 1/3211; F25B 49/022; B60H 2001/3272; F25B 2600/0253

(57) ABSTRACT

A vehicle air-conditioning apparatus includes: a refrigerant circuit including a compressor, an indoor and an external heat exchange unit; and a control device configured to control the refrigerant circuit, in which the refrigerant circuit includes: a hot gas bypass that causes at least a part of a refrigerant compressed by the compressor to be decompressed and return to the compressor without passing through the indoor and the external heat exchange unit; and a flow rate adjustment portion that adjusts a flow rate of the refrigerant flowing through the hot gas bypass, and in a hot gas heating mode the control device drives the compressor at a predetermined fixed rotation speed at start of the hot gas heating mode, and then executes an FF/FB mode that controls a rotation speed of the compressor under FF control and FB control and sets a predetermined initial value in an integral term of FB.

### TECHNICAL FIELD

The present invention relates to a vehicle air-conditioning apparatus.

### BACKGROUND ART

In recent years, vehicles such as hybrid vehicles and electric vehicles that drive a motor for traveling with electric power supplied from a battery mounted on the vehicle have become widespread. As such a vehicle air-conditioning apparatus mounted on a vehicle, a vehicle air-conditioning apparatus using a heat pump (refrigerant circuit) as a heat source is known.

The vehicle air-conditioning apparatus using the heat pump causes an external heat exchanger to function as a heat absorber during heating operation to obtain a heating source from the outside air. Hence, when the outside temperature becomes very low, it becomes difficult to absorb heat from the outside air, and the heating capacity is significantly reduced. In contrast, as effective heating under a very low temperature environment, hot gas heating is known which uses a high-temperature, high-pressure refrigerant discharged from a compressor of a refrigerant circuit without absorbing heat from, for example, the outside air.

For example, in a vehicle air-conditioning apparatus of Patent Literature 1, hot gas heating operation is performed by circulating a refrigerant in a heat pump as follows: In other words, in the heat pump, a part of a high-temperature, high-pressure refrigerant discharged from a compressor flows through a bypass channel to be decompressed, and then is returned to the compressor. The remaining high-temperature, high-pressure refrigerant exchanges heat with the air to be blown into a vehicle's cabin in an indoor heat exchanger, and then is decompressed and returned to the compressor without passing through an external heat exchanger.

### CITATION LIST

### Patent Literature

Patent Literature 1: JP-A-2023-46604

### SUMMARY OF INVENTION

### Problems to be Solved by Invention

In such a vehicle air-conditioning apparatus described above, the compressor is normally controlled in such a manner as to be driven at a target rotation speed calculated in a predetermined cycle under feedforward control (hereinafter FF control) and feedback control (hereinafter FB control) from the start of the hot gas heating operation. In this case, for example, at the start of hot gas heating, it takes time for the compressor at rest to be driven at the maximum rotation speed. Therefore, rapid heating capability is insufficient, and the comfort of a user may be impaired.

In contrast, if the compressor is driven at a high fixed rotation speed from the start of the hot gas heating operation and this state is maintained for a certain period of time or longer in order to ensure the rapid heating capability, noise vibration harshness (NVH) occurs and the endurance of the compressor is reduced. Moreover, if the compressor is driven at the fixed rotation speed, there is a problem that the refrigerant pressure cannot be adjusted when a disturbance is inputted.

Hence, it is conceivable that if the compressor is driven at the fixed rotation speed at the start of the hot gas heating operation, and then, for example, the outlet temperature or outlet refrigerant pressure of the indoor heat exchanger reaches a target value, the compressor is switched to FF control and FB control, and controlled.

However, at the time of switching to FF control and FB control, there is very little or a short execution time for FB control before the switching. Therefore, an integral term of FB control is small, and the calculated target rotation speed is a value less than the fixed rotation speed before the switching. Hence, at the time of switching to FF control and FB control, the rotation speed of the compressor decreases temporarily, which causes fluctuations in discharge temperature, and the comfort of the user may be impaired.

The present invention has been made in view of such circumstances, and an object thereof is, for example, to, in hot gas heating operation, suppress fluctuations in discharge temperature and improve the comfort of a user while securing rapid heating capability.

### Solution to Problems

The present invention provides a vehicle air-conditioning apparatus including: a refrigerant circuit including a compressor, an indoor heat exchange unit, and an external heat exchange unit; and a control device configured to control the refrigerant circuit, in which the refrigerant circuit includes: a hot gas bypass that causes at least a part of a refrigerant compressed by the compressor to be decompressed and return to the compressor without passing through the indoor heat exchange unit and the external heat exchange unit; and a flow rate adjustment portion that adjusts a flow rate of the refrigerant flowing through the hot gas bypass, and the control device is capable of executing a hot gas heating mode that causes a part of the refrigerant compressed by the compressor to flow into the indoor heat exchange unit and the remaining refrigerant to flow through the hot gas bypass, and in the hot gas heating mode, executes a fixed mode that drives the compressor at a predetermined fixed rotation speed at start of the hot gas heating mode, and then executes an FF/FB mode that controls a rotation speed of the compressor under feedforward control and feedback control and sets a predetermined initial value in an integral term of feedback control at the time of switching from the fixed mode to the FF/FB mode.

### Effects of Invention

According to the present invention, it is possible to, in hot gas heating operation, suppress fluctuations in discharge temperature and improve the comfort of a user while securing rapid heating capability.

### BRIEF DESCRIPTION OF DRAWINGS

FIG. 1 is an explanatory diagram illustrating a system configuration example of a vehicle air-conditioning apparatus according to an embodiment of the present invention.

FIG. 2 is an explanatory diagram illustrating a control device of the vehicle air-conditioning apparatus according to the embodiment of the present invention.

FIG. 3 is a diagram illustrating a configuration of the control device and the like in an electric vehicle (EV) according to the embodiment of the present invention.

FIG. 4 is an explanatory diagram illustrating the operation of a refrigerant circuit during heat absorption heating operation in the vehicle air-conditioning apparatus according to the embodiment of the present invention.

FIG. 5 is an explanatory diagram illustrating the operation of the refrigerant circuit during hot gas heating operation in the vehicle air-conditioning apparatus according to the embodiment of the present invention.

FIG. 6 is a graph illustrating an example of behavior of an outlet refrigerant pressure of an indoor heat exchanger, a rotation speed of a compressor, and a discharge temperature during the hot gas heating operation by a control method according to a reference example.

FIG. 7 is a graph illustrating an example of the behavior of the outlet refrigerant pressure of the indoor heat exchanger, the rotation speed of the compressor, and the discharge temperature during the hot gas heating operation by a control method according to the embodiment of the present invention.

### DESCRIPTION OF EMBODIMENTS

An embodiment of the present invention is described hereinafter with reference to the drawings. In the following description, the same reference signs in different drawings indicate parts having the same functions, and redundant descriptions in the drawings are omitted as appropriate. Note that a thick black line in a refrigerant circuit 10 in the drawings indicates a refrigerant channel along which a high-pressure refrigerant flows, and a hollow line indicates a refrigerant channel along which the decompressed refrigerant flows. Moreover, a broken line in the refrigerant circuit 10 indicates a refrigerant channel along which the refrigerant does not flow.

### [Configuration of Refrigerant Circuit and the Like]

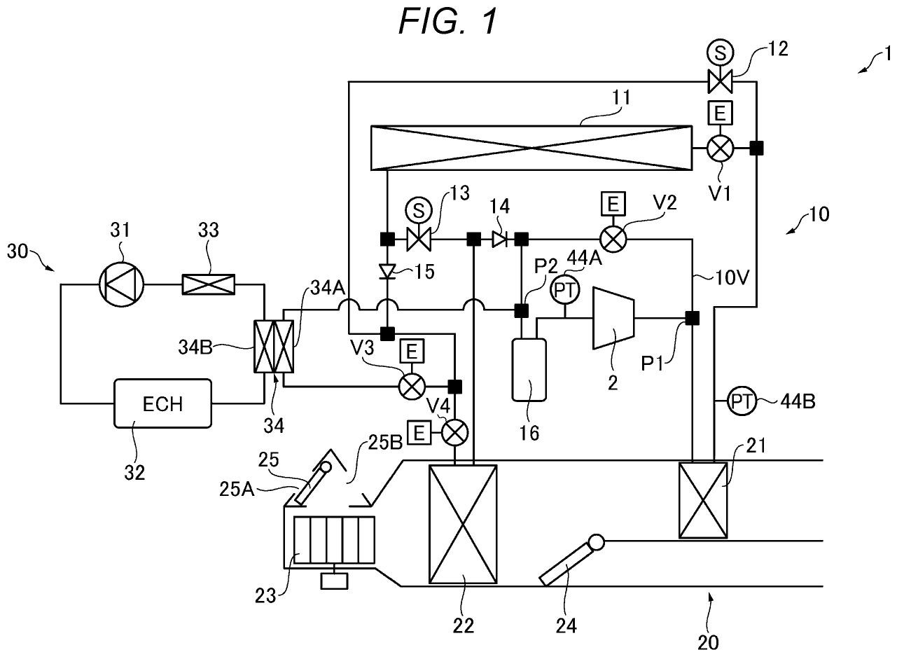

FIG. 1 illustrates a configuration example of a vehicle air-conditioning apparatus 1 according to the embodiment of the present invention. The configuration example presented here is an example, and the configuration is not particularly limited to a specific configuration.

The vehicle air-conditioning apparatus 1 includes the refrigerant circuit 10 and an air-conditioning unit 20. The refrigerant circuit 10 includes a compressor 2, indoor heat exchangers 21 and 22 provided in the air-conditioning unit 20, and an external heat exchanger 11 provided outside a vehicle's cabin, and they are disposed along the refrigerant channels. The indoor heat exchangers 21 and 22 are provided to exchange heat between air flowing in the air-conditioning unit 20 and the refrigerant, and the external heat exchanger 11 is provided to exchange heat between the outside air and the refrigerant outside the cabin. The indoor heat exchanger 21 is for heating air, and the indoor heat exchanger 22 is for cooling air. A refrigerant pressure sensor 44B that detects an outlet refrigerant pressure Pci (a high-pressure side refrigerant pressure) that exits the indoor heat exchanger 21 is provided immediately on a downstream side of the indoor heat exchanger 21.

The compressor 2 compresses the refrigerant, and circulates the refrigerant in the refrigerant circuit 10. The refrigerant compressed by the compressor 2 is decompressed to a necessary pressure by passing through a first decompression portion V1, a second decompression portion V2, a third decompression portion V3, and a fourth decompression portion V4, which are, for example, expansion valves, in the refrigerant channel that is selected as appropriate. The refrigerant circuit 10 is provided with channel switching valves 12 and 13 for switching the refrigerant channel, and check valves 14 and 15 for regulating a refrigerant flow direction. An accumulator 16 that recovers liquid refrigerant and separates the refrigerant into gas and liquid is provided immediately on an upstream side of the compressor 2 in the refrigerant circuit 10. A refrigerant pressure sensor 44A that detects a refrigerant suction pressure Ps (a low-pressure side refrigerant pressure) to be sucked into the compressor 2 is provided between the accumulator 16 and the compressor 2.

As described above, the air-conditioning unit 20 includes the indoor heat exchangers 21 and 22 therein, and the air that is introduced by a fan 23 from inside or outside the interior of the vehicle is discharged into the interior through the indoor heat exchangers 21 and 22. The air-conditioning unit 20 is provided with an air damper 24. When the air damper 24 illustrated in FIG. 1 is fully open, the air that is introduced by the fan 23 is discharged into the interior through both of the indoor heat exchangers 21 and 22.

Moreover, when the air damper 24 is fully closed, a suction side of the indoor heat exchanger 21 is blocked, and the air that is introduced by the fan 23 is discharged into the interior only through the indoor heat exchanger 22. Another air damper 25 provided to the air-conditioning unit 20 switches the air to be introduced into the fan 23 between air inside and outside the interior. The air damper 25 can selectively close an air introduction port 25A connected to the outside of the interior and an air introduction port 25B connected to the interior to take in air through either of them. Moreover, air can also be taken in through both of the air introduction port 25A and the air introduction port 25B by, for example, placing the air damper 25 in between.

Note that the example where in the above-mentioned external heat exchanger 11 and indoor heat exchangers 21 and 22, the refrigerant and the air exchange heat directly has been described. However, the refrigerant and the air may exchange heat indirectly through a heating medium that has exchanged heat with the refrigerant. In other words, it may also be configured in such a manner that the refrigerant absorbs heat from the air through the heating medium, or the refrigerant may dissipate heat into the air through the heating medium.

As illustrated in FIG. 1, the vehicle air-conditioning apparatus 1 includes a heating medium circuit 30. In the heating medium circuit 30, the heating medium is circulated by a circulation pump 31 and heated by a heater (ECH: Electric Coolant Heater) 32, and waste heat of a temperature adjustment target such as a battery is recovered by a temperature adjustment target heat exchanger 33. In addition, the refrigerant circuit 10 and the heating medium circuit 30 are provided with a refrigerant-heating medium heat exchanger 34 that exchanges heat between the refrigerant and the heating medium in a channel 34A along which the refrigerant flows and a channel 34B along which the heating medium flows. The heating medium circuit 30 is provided when needed.

### [Control Device]

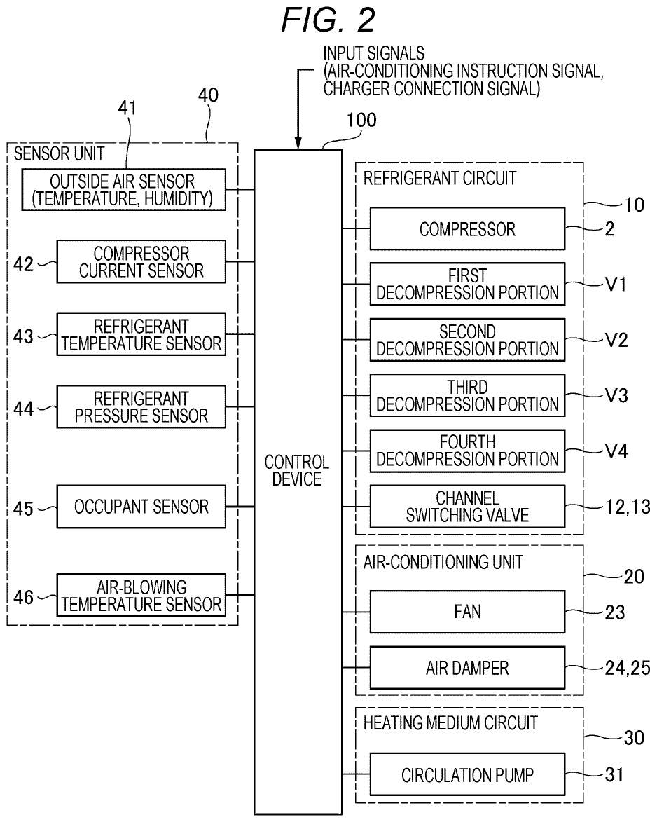

The vehicle air-conditioning apparatus 1 includes a control device 100 illustrated in FIG. 2. The control device 100 controls the above-mentioned refrigerant circuit 10, air-conditioning unit 20, and heating medium circuit 30 on the basis of various input signals (such as an air-conditioning instruction signal and a charger connection signal) and a detection signal from a sensor unit 40.

The sensor unit 40 that inputs the detection signal into the control device 100 includes, for example, an outside air sensor 41 that detects an outside air state such as an outside temperature and an outside humidity, a compressor current sensor 42 for detecting the power consumption (energy consumption) of the compressor 2, a refrigerant temperature sensor 43 and a refrigerant pressure sensor 44 that detect a refrigerant state, an occupant sensor 45 that detects the presence or absence of an occupant in the cabin, and an air-blowing temperature sensor 46 that detects the air-blowing temperature of the air-conditioning unit 20.

In particular, the refrigerant pressure sensor 44 includes a refrigerant pressure sensor 44A that detects the refrigerant suction pressure Ps (the low-pressure side refrigerant pressure) to be sucked into the compressor 2, and a refrigerant pressure sensor 44B that detects the outlet refrigerant pressure Pci (the high-pressure side refrigerant pressure) of the indoor heat exchanger 21 (refer to FIG. 1). These sensors are examples, and various sensors that detect information necessary for the control device 100 to perform various types of control are provided as the sensor unit 40.

Control targets of the control device 100 include the compressor 2, the first decompression portion V1, the second decompression portion V2, the third decompression portion V3, the fourth decompression portion V4, and the channel switching valves 12 and 13 in the refrigerant circuit 10, the fan 23 and the air dampers 24 and 25 in the air-conditioning unit 20, and the circulation pump 31 in the heating medium circuit 30. Moreover, the control device 100 controls the vehicle air-conditioning apparatus 1 in accordance with a process result of the control device 100. In the vehicle air-conditioning apparatus 1, the control device 100 can switch between heat absorption heating operation in which the refrigerant absorbs heat in the external heat exchanger 11 and hot gas heating operation in which the refrigerant compressed by the compressor 2 dissipates heat in the indoor heat exchanger 21 without the refrigerant absorbing heat in the external heat exchanger 11 to heat the cabin, and executes the heating operation.

### [Configuration of Control Device in Electric Vehicle (EV)]

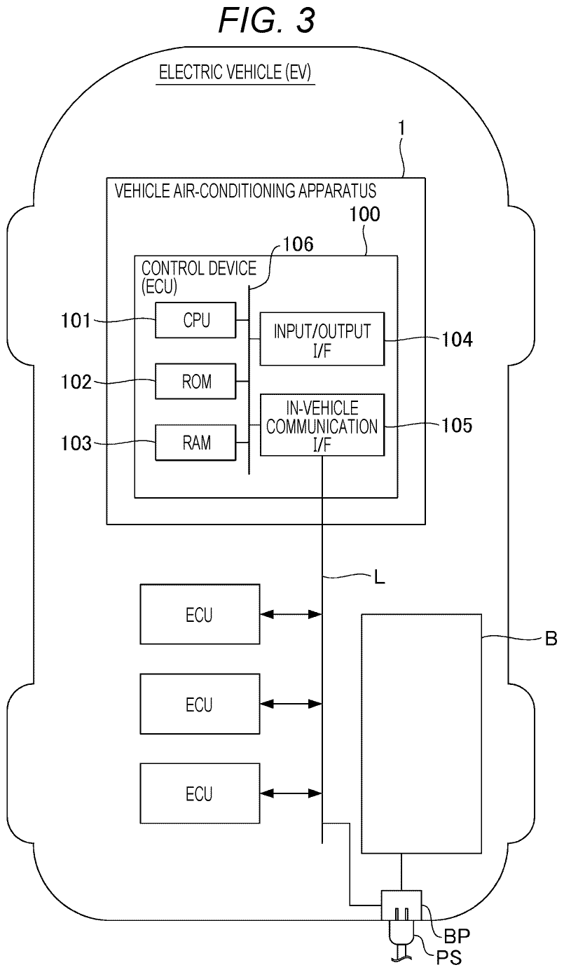

As illustrated in FIG. 3, the control device 100 included in the vehicle air-conditioning apparatus 1 is configured as one electronic control unit (ECU) connected to various ECUs that control an electric vehicle (EV) via an in-vehicle network L. The control device 100 includes a central processing unit (CPU) 101, a read only memory (ROM) 102, a random access memory (RAM) 103, an input/output interface (I/F) 104, and an in-vehicle communication interface (I/F) 105, and these pieces of hardware are connected to one another via a bus 106.

The CPU 101 executes various programs stored in the ROM 102 to control the control device 100. The ROM 102 is a non-volatile memory. The ROM 102 stores, for example, the programs to be executed by the CPU 101 and data necessary for the CPU 101 to execute the programs. The RAM 103 is a main storage device such as dynamic random access memory (DRAM) or static random access memory (SRAM).

The RAM 103 functions as, for example, a work area that is used when the CPU 101 executes the programs. The input/output I/F 104 is connected to various sensors and monitors, which are installed in the EV, and inputs data into the CPU 101 and outputs data on which the CPU 101 has performed a computing process. The in-vehicle communication I/F 105 is connected to the in-vehicle network L to control data transmission and reception to and from other ECUs set in the EV.

Data on surrounding environmental information or data on the driving state of the EV is inputted into the control device 100 via the input/output I/F 104 or the in-vehicle communication I/F 105 and therefore, the control device 100 controls the above-mentioned vehicle air-conditioning apparatus 1 on the basis of a program executed by the CPU 101.

A battery B is mounted on the EV. A plug PS of a charger is connected to a battery plug BP to charge the battery B, and power is supplied to the vehicle air-conditioning apparatus 1 through the battery B. The state in which the plug PS is connected to the battery plug BP is transmitted as the charger connection signal to the control device 100 via the in-vehicle network L.

### [Heat Absorption Heating Operation]

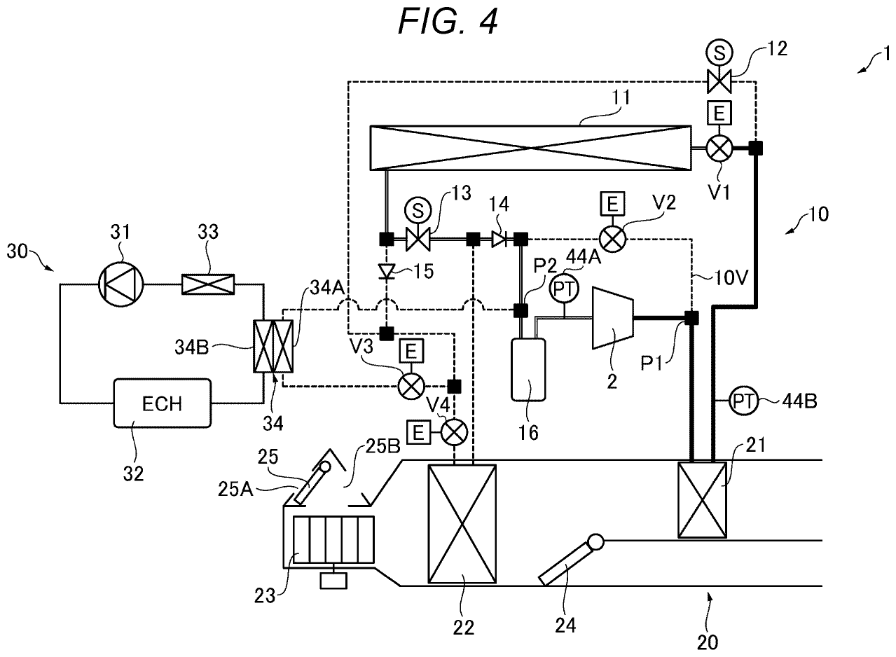

The operation of the refrigerant circuit 10 during the heat absorption heating operation is described with reference to FIG. 4. In the refrigerant circuit 10 during the heat absorption heating operation, the second decompression portion V2, the third decompression portion V3, the fourth decompression portion V4, and the channel switching valve 12 are fully closed. On the other hand, the channel switching valve 13 is fully open, and the first decompression portion V1 is open.

During the heat absorption heating operation, the high-temperature, high-pressure refrigerant discharged from the compressor 2 passes through the indoor heat exchanger 21 in the air-conditioning unit 20 and is decompressed in the first decompression portion V1, and the low-pressure refrigerant passes through the external heat exchanger 11 and is returned to the compressor 2 through the channel switching valve 13, the check valve 14, and the accumulator 16. At this point in time, the high-pressure refrigerant discharged from the compressor 2 condenses and dissipates heat in the indoor heat exchanger 21, is decompressed into the low-pressure refrigerant in the first decompression portion V1, absorbs heat and evaporates in the external heat exchanger 11, and returns to the compressor 2. In addition, in the air-conditioning unit 20, the air introduced by the fan 23 is heated by the heat dissipated in the indoor heat exchanger 21, and is discharged into the cabin.

### [Hot Gas Heating Operation]

It is difficult to absorb heat in the external heat exchanger 11 at very low temperatures. Therefore, hot gas heating is used. In the hot gas heating operation, a part or whole of the refrigerant compressed by the compressor 2 dissipates heat in the indoor heat exchanger 21, without causing the refrigerant to absorb heat in the external heat exchanger 11, to heat the cabin.

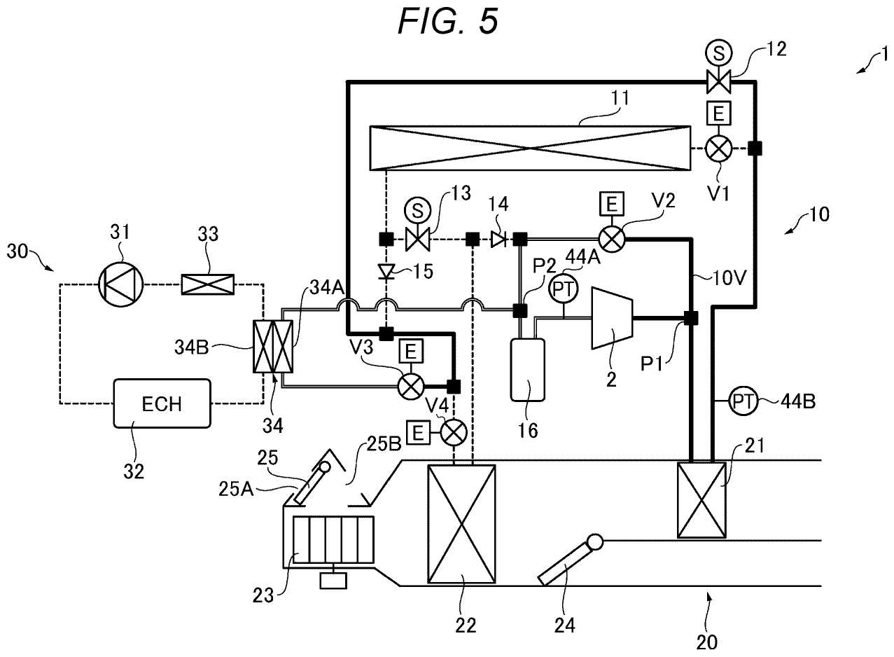

The operation of the refrigerant circuit 10 during the hot gas heating operation is described with reference to FIG. 5. In this operation, a part of the high-temperature, high-pressure refrigerant discharged from the compressor 2 passes through the indoor heat exchanger 21 and the channel switching valve 12, is decompressed into the low-pressure refrigerant in the third decompression portion V3, passes through the refrigerant-heating medium heat exchanger 34, is separated into gas and liquid in the accumulator 16, and returns to the compressor 2. At this point in time, in the refrigerant circuit 10, the first decompression portion V1 is fully closed to prevent the refrigerant from flowing into the external heat exchanger 11. Moreover, the fourth decompression portion V4 is fully closed to prevent the refrigerant from flowing into the indoor heat exchanger 22.

The refrigerant circuit 10 includes a hot gas bypass 10V that causes at least a part of the refrigerant compressed by the compressor 2 to be decompressed and return to the compressor 2 without passing through the indoor heat exchanger 21 and the external heat exchanger 11. In the hot gas bypass 10V, the part of the high-temperature, high-pressure refrigerant branches at a branch point P1 immediately on a downstream side of the compressor 2, is decompressed in the second decompression portion V2, and merges into the low-pressure refrigerant decompressed by the third decompression portion V3 at a junction point P2 immediately on an upstream side of the accumulator 16.

With such a hot gas bypass TOV provided, it is possible to mix the gaseous refrigerant that has passed through the hot gas bypass TOV with the liquid refrigerant that has been condensed by the heat dissipation in the indoor heat exchanger 21 to obtain the gas-rich refrigerant and then return the refrigerant to the compressor 2. Moreover, if the flow rate of the refrigerant that flows through the hot gas bypass 10V is increased, it is possible to suppress the amount of heat dissipated in the indoor heat exchanger 21 and, if the flow rate of the refrigerant that flows through the hot gas bypass TOV is adjusted by opening and closing the second decompression portion V2, it is possible to keep a balance between the amount of heat dissipated in the refrigerant circuit 10 and the amount of heat inputted into the compressor 2. In other words, the second decompression portion V2 functions as a flow rate adjustment portion that adjusts the flow rate of the refrigerant that flows through the hot gas bypass 10V.

The flow of the refrigerant during the hot gas heating operation is decompressed by the third decompression portion V3 in the channel passing through the indoor heat exchanger 21, and therefore, becomes the high-pressure refrigerant on an upstream side of the third decompression portion V3 and becomes the low-pressure refrigerant on a downstream side thereof. At this point in time, it is important that heat is not exchanged in the refrigerant-heating medium heat exchanger 34 in the low-pressure side channel in order to maintain heating capacity. In addition, in the air-conditioning unit 20, the air introduced by the fan 23 is heated by the heat dissipated in the indoor heat exchanger 21, and is discharged into the cabin.

### [Control of Compressor During Hot Gas Heating Operation]

During the hot gas heating operation of the vehicle air-conditioning apparatus 1, the control device 100 controls the compressor 2 in a fixed mode and an FF/FB mode. In other words, at the start of hot gas heating, the control device 100 executes the fixed mode to control the compressor 2 in such a manner as to drive the compressor 2 at a predetermined fixed rotation speed, and then executes the FF/FB mode to control the compressor 2 in such a manner that the high-pressure side refrigerant pressure of the refrigerant circuit 10 (which is assumed in the embodiment to be the outlet refrigerant pressure Pci of the indoor heat exchanger 21) reaches a target pressure (a target outlet refrigerant pressure PCO) under FF control and FB control.

The control of the compressor 2 during the hot gas heating operation in the vehicle air-conditioning apparatus 1 is described below in comparison with a reference example.

### (Control Method According to Reference Example)

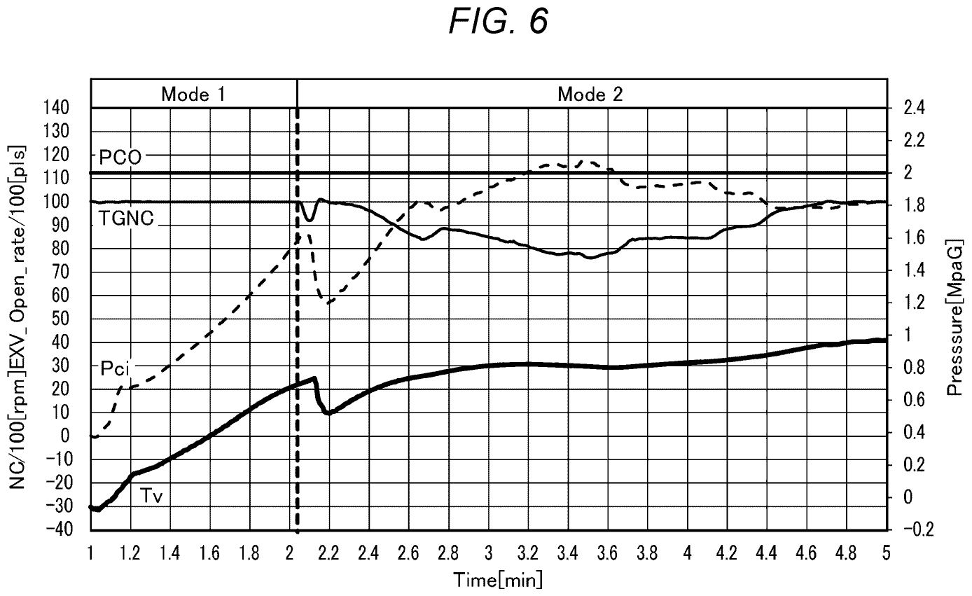

FIG. 6 is a graph illustrating an example of the behavior of the outlet refrigerant pressure Pci (the high-pressure side refrigerant pressure) of the indoor heat exchanger 21, a target rotation speed TGNC of the compressor 2, and a discharge temperature Tv during the hot gas heating operation by a control method according to a reference example. Note that in the example of FIG. 6, the fixed mode is executed in a period indicated with “Mode 1,” and the FF/FB mode is executed in a period indicated with “Mode 2.”

In the following description, in terms of the target rotation speed TGNC of the compressor 2, let the fixed rotation speed of the compressor 2 in the fixed mode be TGNCf, and let the target rotation speed calculated by the control device 100 in the FF/FB mode be TGNCz.

In the period of Mode 1 illustrated in FIG. 6, the control device 100 is driven, taking the fixed rotation speed TGNCf for the target rotation speed TGNC of the compressor 2 in the fixed mode, and following this, both of the outlet refrigerant pressure Pci and the discharge temperature Tv increase. If detecting that the discharge temperature Tv has increased to or above a predetermined threshold, the control device 100 switches from the fixed mode to the FF/FB mode and controls the compressor 2 under FF control and FB control.

The control device 100 controls the rotation speed of the compressor 2 under FF control and FB control in the FF/FB mode. In other words, the control device 100 calculates the target rotation speed TGNCz of the compressor 2 in a predetermined control cycle on the basis of a difference between the target outlet refrigerant pressure PCO and the outlet refrigerant pressure Pci, and drives the compressor 2 in accordance with the calculated target rotation speed TGNCz.

Specifically, the control device 100 calculates an FF term TGNCh_FF as an FF manipulated variable of the target rotation speed TGNCz on the basis of the outlet refrigerant pressure Pci and the target outlet refrigerant pressure PCO. Similarly, the control device 100 calculates an FB manipulated variable TGNCh_FB of the target rotation speed TGNCz with PID (proportional-integral-derivative) computation or PI (proportional-integral) computation based on the outlet refrigerant pressure Pci and the target outlet refrigerant pressure PCO.

The control device 100 adds the FF term TGNCh_FF as the FF manipulated variable and the FB manipulated variable TGNCh_FB to calculate the target rotation speed TGNCz of the compressor 2. In other words, the target rotation speed TGNCz of the compressor 2 is expressed by the following equation (1):

$$TGNCz = TGNCh\_FF + TGNCh\_FB \qquad ( 1 )$$

Here, the FB manipulated variable TGNCh_FB includes a proportional term TGNCh_FB_P, an integral term TGNCh_FB_I, and a previous integral term value TGNCh_FB_Iz. However, at the time of switching to the FF/FB mode, there is no execution period of the FF/FB mode before the switching, and therefore, the integral term TGNCh_FB_I and the previous integral term value TGNCh_FB_Iz of the FB manipulated variable TGNCh_FB are zero.

Due to an influence of this, the target rotation speed TGNCz calculated by the control device 100 is smaller than the fixed rotation speed TGNCf. Therefore, the target rotation speed TGNC of the compressor 2 decreases temporarily at the time of switching from the fixed mode to the FF/FB mode, and following this, the outlet refrigerant pressure Pci decreases. Therefore, the discharge temperature Tv also decreases. The integral term is then added with the execution of the FF/FB mode, and the target rotation speed TGNCz is adjusted on the basis of the outlet refrigerant pressure Pci. However, it takes time for the outlet refrigerant pressure Pci to reach the target outlet refrigerant pressure PCO, and it takes time for the discharge temperature Tv to stabilize (refer to FIG. 6).

In this manner, upon switching from the fixed mode to the FF/FB mode, the target rotation speed TGNC of the compressor 2 fluctuates, for example, decreasing temporarily, and following this, the discharge temperature Tv also fluctuates. Therefore, the comfort of the user is impaired.

### (Control Method According to Embodiment)

Hence, in the embodiment, upon switching from the fixed mode to the FF/FB mode during the hot gas heating operation, the control device 100 suppresses fluctuations in the target rotation speed TGNC of the compressor 2 in the hot gas heating operation by computing the target rotation speed TGNCz of the compressor 2 in the FF/FB mode as follows.

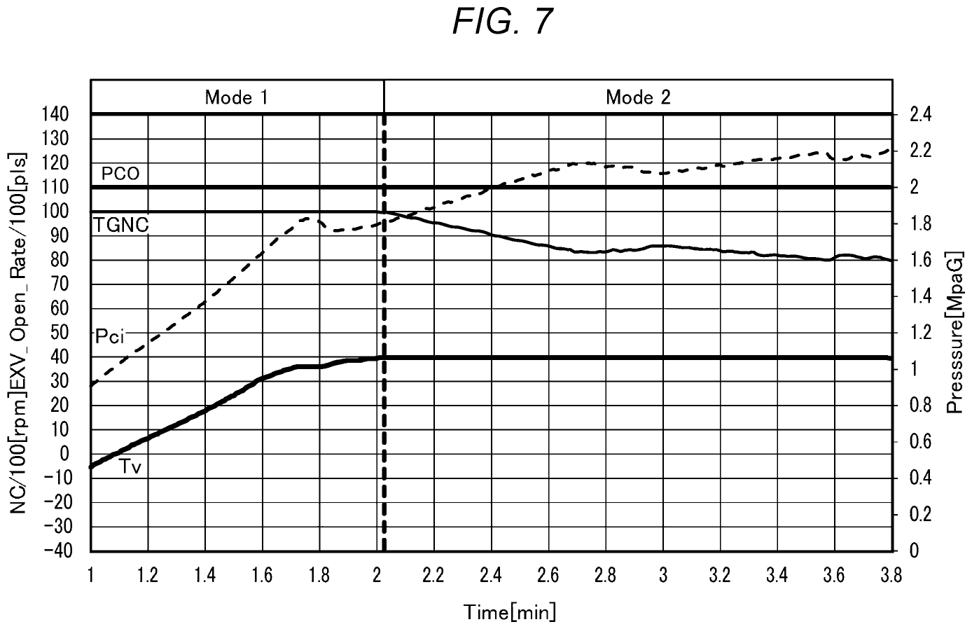

FIG. 7 is a graph illustrating an example of the behavior of the outlet refrigerant pressure Pci (the high-pressure side refrigerant pressure) of the indoor heat exchanger 21, the target rotation speed TGNC of the compressor 2, and the discharge temperature Tv. The control device 100 controls the rotation speed of the compressor 2 in the fixed mode and the FF/FB mode. In the example of FIG. 7, the control device 100 executes the fixed mode in the period indicated with “Mode 1,” and executes the FF/FB mode in the period indicated with “Mode 2.” Also in the description of FIG. 7, in terms of the target rotation speed TGNC of the compressor 2, let the fixed rotation speed of the compressor 2 in the fixed mode be TGNCf, and let the target rotation speed calculated by the control device 100 in the FF/FB mode be TGNCz.

In the period of Mode 1 illustrated in FIG. 7, the control device 100 is driven, applying the fixed rotation speed TGNCf as the target rotation speed TGNC of the compressor 2. The control device 100 takes the larger of the target rotation speed that is calculated on the basis of the outside temperature and the target rotation speed that is calculated on the basis of the user setting for the fixed rotation speed TGNCf. The hot gas heating operation is executed when the outside temperature is very low. Therefore, both of the target rotation speed that is calculated on the basis of the outside temperature and the target rotation speed that is calculated on the basis of the user setting are in a high rotation speed region within a rotation speed range in which the compressor 2 can be driven.

In the fixed mode, the compressor 2 is driven at a relatively high fixed rotation speed. Therefore, both of the outlet refrigerant pressure Pci and the discharge temperature Tv increase relatively quickly, so that rapid heating capability can be secured. If the outlet refrigerant pressure Pci exceeds a predetermined threshold in the fixed mode, the control device 100 drives the fan 23 to start blowing air into the cabin. As a result, in the indoor heat exchanger 21, heat is exchanged between the high-temperature, high-pressure refrigerant and the air passing through the indoor heat exchanger 21, and the outlet refrigerant pressure Pci decreases slightly and increases again.

If subsequently detecting that the discharge temperature Tv has increased to or above a predetermined threshold, the control device 100 switches from the fixed mode to the FF/FB mode and controls the rotation speed of the compressor 2 under FF control and FB control.

In the FF/FB mode, the control device 100 drives the compressor 2 at the target rotation speed TGNCz calculated in a predetermined control cycle. The control device 100 adds the FF manipulated variable TGNCh_FF and the FB manipulated variable TGNCh_FB, which have been calculated on the basis of the outlet refrigerant pressure Pci and the target outlet refrigerant pressure PCO, to calculate the target rotation speed TGNCz (the above-mentioned equation (1)).

If there is no change in the target rotation speed TGNC of the compressor 2 at the time of switching from the fixed mode to the FF/FB mode, that is, if the target rotation speed TGNCz at the time of switching to the FF/FB mode, which is calculated by the control device 100, is a value substantially equal to the fixed rotation speed TGNCf in the fixed mode, it is possible to suppress fluctuations in the target rotation speed TGNC of the compressor 2, and by extension fluctuations in the outlet refrigerant pressure Pci and the discharge temperature Tv.

As described above, at the time of switching to the FF/FB mode, the integral term in the FB manipulated variable TGNCh_FB is zero, and an influence of this causes the target rotation speed to fluctuate. Therefore, the control device 100 sets a predetermined initial value D in the integral term in the FB manipulated variable TGNCh_FB to compensate for the fluctuation.

Specifically, the control device 100 sets the initial value D obtained by the fixed rotation speed TGNCf, the FF term TGNCh_FF, and the proportional term TGNCh_FB_P in the integral term in the FB manipulated variable TGNCh_FB as expressed by the following equation (2):

$$D = TGNCf - TGNCh\_FF - TGNCh\_FB \_P \qquad ( 2 )$$

Note that the control device 100 may use, as the initial value, a value computed from, for example, a simulation and stored in advance in, for example, the ROM 102 as long as it is a value that makes the target rotation speed TGNCz at the time of switching to the FF/FB mode substantially equal to the fixed rotation speed TGNCf in the fixed mode.

At the time of switching to the FF/FB mode, in the control device 100, the target rotation speed TGNCz obtained by adding the FB manipulated variable TGNCh_FB in which such an initial value D is set and the FF manipulated variable TGNCh_FF is a value substantially equal to the fixed rotation speed TGNCf. Therefore, at the time of switching from the fixed mode to the FF/FB mode, the fluctuations in the rotation speed of the compressor 2 are suppressed, and the fluctuations in the outlet refrigerant pressure Pci and the discharge temperature Tv are also suppressed.

In this manner, according to the embodiment, upon the hot gas heating operation, the control device 100 drives the compressor 2 at a relatively high fixed rotation speed in the fixed mode at the time of start to increase the outlet refrigerant pressure Pci at an early stage, and therefore can secure the rapid heating capability. Moreover, if detecting that the discharge temperature Tv has exceeded the predetermined threshold during the execution of the fixed mode, the control device 100 switches to the FF/FB mode to secure responsiveness to a disturbance.

Furthermore, at the time of switching from the fixed mode to the FF/FB mode, the predetermined initial value D is set in the integral term of the FB manipulated variable TGNCh_FB. Therefore, the target rotation speed TGNCz substantially equal to the fixed rotation speed TGNCf in the fixed mode is calculated to drive the compressor 2 at the calculated target rotation speed TGNCz. Consequently, at the time of switching from the fixed mode to the FF/FB mode, that is, when the target rotation speed TGNC of the compressor 2 is switched from the fixed rotation speed TGNCf to the target rotation speed TGNCz, the fluctuations in the rotation speed of the compressor 2 are suppressed, and as a result, the fluctuations in the outlet refrigerant pressure Pci and the discharge temperature Tv are also suppressed.

As described above, according to the embodiment, it is possible to, in the hot gas heating operation, suppress the fluctuations in the discharge temperature and improve the comfort of the user while securing the rapid heating capability.

Up to this point the embodiments of the present invention have been described in detail with reference to the drawings. However, the specific configurations are not limited to these embodiments, and, for example, modifications to the design within the scope that does not depart from the purport of the present invention are also included in the present invention.

### LIST OF REFERENCE SIGNS

1 Vehicle air-conditioning apparatus
2 Compressor
10 Refrigerant circuit
10V Hot gas bypass
11 External heat exchanger
12, 13 Channel switching valve
14, 15 Check valve
16 Accumulator
20 Air-conditioning unit
21, 22 Indoor heat exchanger
23 Fan
24, 25 Air damper
25A, 25B Air introduction port
30 Heating medium circuit
31 Circulation pump
33 Temperature adjustment target heat exchanger
34 Refrigerant-heating medium heat exchanger
34A, 34B Channel
40 Sensor unit
41 Outside air sensor
42 Compressor current sensor
43 Refrigerant temperature sensor
44, 44A, 44B Refrigerant pressure sensor
45 Occupant sensor
46 Air-blowing temperature sensor
100 Control device

1. A vehicle air-conditioning apparatus comprising:
a refrigerant circuit including a compressor, an indoor heat exchange unit, and an external heat exchange unit; and
a control device configured to control the refrigerant circuit, wherein
the refrigerant circuit includes: a hot gas bypass that causes at least a part of a refrigerant compressed by the compressor to be decompressed and return to the compressor without passing through the indoor heat exchange unit and the external heat exchange unit; and a flow rate adjustment portion that adjusts a flow rate of the refrigerant flowing through the hot gas bypass, and
the control device
is capable of executing a hot gas heating mode that causes a part of the refrigerant compressed by the compressor to flow into the indoor heat exchange unit and the remaining refrigerant to flow through the hot gas bypass, and
in the hot gas heating mode, executes a fixed mode that drives the compressor at a predetermined fixed rotation speed at start of the hot gas heating mode, and then executes an FF/FB mode that controls a rotation speed of the compressor under feedforward control and feedback control and sets a predetermined initial value in an integral term of feedback control at the time of switching from the fixed mode to the FF/FB mode.

2. The vehicle air-conditioning apparatus according to claim 1, wherein the initial value is a value calculated on the basis of a feedforward term and a proportional term of a target rotation speed calculated in the FF/FB mode, and the fixed rotation speed.

3. The vehicle air-conditioning apparatus according to claim 1, wherein the control device executes the fixed mode, taking the larger of a target rotation speed calculated on the basis of an outside temperature and a target rotation speed calculated on the basis of a user setting for the fixed rotation speed as a target rotation speed of the compressor.

4. The vehicle air-conditioning apparatus according to claim 1, wherein the control device switches from the fixed mode to the FF/FB mode upon a discharge temperature of air to be blown into a vehicle's cabin being equal to or greater than a predetermined threshold.
